(19) United States
(12) Patent Application Publication
(10) Pub. No.: US 2020/0048969 A1
(43) Pub. Date: Feb. 13, 2020

(54) Tubular Locking Ring

(71) Applicant: Cameron International Corporation, Houston, TX (US)

(72) Inventors: Brynjulv Aas, Kristiansand (NO); Magnus Berg, Oevreboe (NO)

(21) Appl. No.: 16/100,127

(22) Filed: Aug. 9, 2018

(51) Int. Cl. E21B 17/043; F16B 7/04

(52) U.S. Cl. CPC E21B 17/043; E21B 17/06; F16B 7/0413

(57) ABSTRACT

Embodiments of a locking ring assembly of this disclosure may be used to prevent unwanted rotation of a drill stem sub or tubular when another sub or tubular of the drill stem is subjected to a disconnect or reverse torque force. The locking ring assembly may include an upper and a lower rings having two halves connected on one end by a hinge and on another end by a fastener. Each locking ring half may include convexities located along an inner wall surface. When locking ring is in a closed position the convexities at least partly penetrate an opposing surface of the drill stem sub or tubular, thereby maintaining locking force by shear force rather than friction force. One or more keys may be installed between the upper and lower rings to prevent undesired or excessive torque experienced by one ring being transmitted to the other.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

This disclosure is in the field of locking rings like those that may be used for locking drill stem subs or tubulars in a top drive of an oil and gas drill string.

Whether onshore or offshore, a drilling rig can be provided to drill a well to access the desired resource. A drill string can be suspended from the drilling rig and rotated to drill the well. While the drill string can be suspended from a kelly and driven by a rotary table on the drill floor of the drilling rig, in some instances the drill string is instead suspended from and driven by a top drive of the drilling rig. Such a top drive generally includes a quill (also referred to as a main shaft or drive stem) that can be connected to the drill string. The quill provides axial support to the drill string, while a motor in the top drive is connected to the quill to drive rotation of the drill string via the quill. The top drive can be raised and lowered via a hoisting system to raise and lower the drill string within the well

A top drive quill (main) shaft may have three or four subs connected at a lower end. A “sub” generally means any small component of the drill string, such as a drill collar or a threaded crossover connector. For example, in a top drive shaft the subs may include a crossover (intermediate) sub, an upper and a lower inside blowout preventer sub, and a saver sub. The saver sub is typically a short length of drill collar that has male threads on one end and female on the other. This sub may be screwed onto the bottom of the top drive and onto the rest of the drill string. When the hole must be deepened, and pipe added to the drill string, the threads are unscrewed between the saver sub and the rest of the drill string

To break this connection, a back-up tong grabs or clamps onto the top drill string tool joint and a top drive traction motor applies break-out (full reverse) torque. When applying this torque, it is important that only the connection between the top drive lower sub and the drill string becomes loosened and not any other connection between the drill stem subs. Therefore, top drives that use this system for breaking connections typically include locking rings located between adjacent drill stem subs. The locking rings prevent those other connections from breaking loose when the tong and traction motor are being used to break out drill pipe.

Referring to FIGS. 1 & 2, prior art locking rings comprise a multiple-part assembly that generally includes upper and lower flanges and a conical-shaped split ring. The conical-shaped split ring is held in place just over the connection point while the upper and lower flanges are positioned over the ring. A set of fasteners or locking screws are then installed between the flanges and tightened. The flanges provide a significant horizontal clamping force that, due to friction, locks the connection to prevent unwanted rotation during breakout operations.

This connection-breaking and stand-installing process can be time consuming and can present safety concerns. The manual handling that is involved presents a risk of injury to hands and fingers. The multiple-part locking ring assembly presents a risk for dropping loose items into the well bore. Additionally, the prior art locking flange design requires a certain level of surface friction to work properly.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. The embodiments provide designs, examples, or arrangements of a locking ring assembly of this disclosure. The invention may encompass a variety of aspects that may not be set forth below.

Embodiments of a locking ring assembly of this disclosure may be used to prevent unwanted rotation of a drill stem sub or tubular when another sub or tubular of the stem is subjected to a disconnect or reverse torque force like that experienced during breakout operations. In embodiments, the locking ring assembly may include an upper and a lower rings having two halves connected on one end by a hinge and on another end by a fastener. Each locking ring half may include convexities located along an inner wall surface. In some embodiments, the convexities may be on a die. The convexities may be triangular-shaped, square-shaped, rectangle-shaped, bumps, protuberances, nodules, or other shapes preferable. When in a closed and locked position the convexities at least partly penetrate a respective opposing surface of the drill stem sub or tubular, thereby maintaining locking force by shear force rather than friction force. A key may be installed between the upper and lower rings to prevent undesired or excessive torque experienced by one ring being transmitted to the other ring. The key may be configured so that the entire torque is transferred via the key.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings, wherein:

FIG. 1 is an exploded view of an embodiment of a prior art locking ring.

FIG. 2 is a section view of the prior art locking ring of FIG. 1 in a fully connected and locked state (drill stem not shown).

FIG. 3 generally depicts a drilling system in accordance with an embodiment of this disclosure.

FIG. 4 is a block diagram of various components of a top drive in accordance with one embodiment of this disclosure.

FIG. 5 is an isometric view of a locking ring in accordance with an embodiment of this disclosure when in a fully closed and locked position about a sub of a top drive quill.

FIG. 6 is an isomeric view of a locking ring of this disclosure shown in a fully closed and locked position.

FIG. 7 is an isometric view of the locking ring of FIG. 6 shown in a fully opened and unlocked (unclamped) position.

FIG. 8 is a section view of the locking ring of FIG. 6 when in a fully closed and locked (clamped) position. The cross section is shown across the dies with the locking ring grabbing a tool joint connection.

FIG. 9 is a section view of an embodiment of a locking ring of this disclosure. Keys are installed between the upper and lower rings to prevent undesired or excessive torque experienced by one ring being transmitted to the other ring.

FIG. 10 is a section view of the locking ring of FIG. 9 taken along the centerline of one of the keys.

FIG. 11 is an isometric view of the locking ring of FIG. 9. A portion of the locking ring is cut-away to show one of the keys.

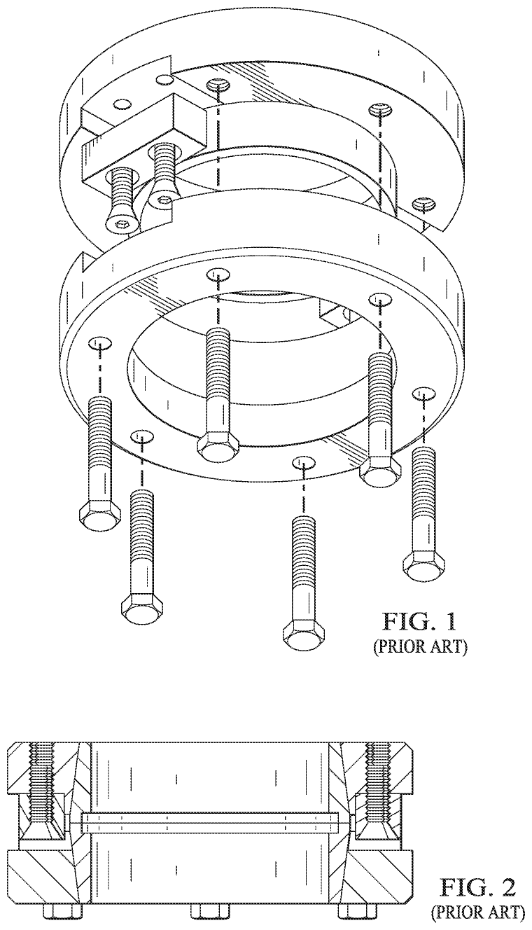

### DETAILED DESCRIPTION

Specific embodiments of the present disclosure are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Moreover, any use of “top,” “bottom,” “above,” “below,” other directional terms, and variations of these terms is made for convenience, but does not require any particular orientation of the components.

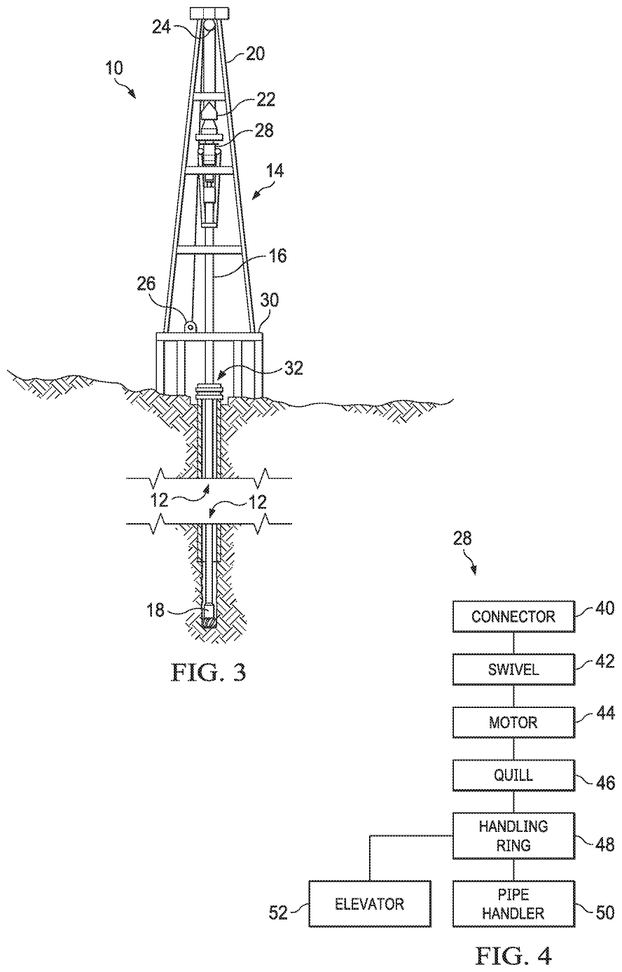

Referring now to FIG. 3, a drilling system 10 is illustrated. The system 10 may be operated to drill a well 12 to access a subterranean resource, such as oil or natural gas. As depicted, the system 10 includes an onshore drilling rig 14, although the system 10 could instead be an offshore system in other embodiments. The drilling rig 14 uses a drill string 16 and a drill bit 18 to form the well 12. The drill string 16 can include various members, such as drill pipes, tool joints, drill collars, and a saver sub that prevents wear on a threaded connection of a rotating system (e.g., a top drive) that drives rotation of the drill string 16.

The drilling rig 14 may also include a hoisting system, —generally shown here as including a mast or derrick 20, a traveling block 22, a crown block 24, and drawworks 26—to enable a top drive 28 to be raised and lowered with respect to a drill floor 30. The drill string 16 (or some other tubular) is suspended from the top drive 28 through a hole in the drill floor 30 and through surface equipment (e.g., a blowout preventer 32). The drill string 16 can be rotated by the top drive 28 and can be raised and lowered with the top drive 28 (via the traveling block 22) to facilitate drilling operations.

One schematic example of elements of a top drive 28 is generally depicted in FIG. 4. In this embodiment, the top drive 28 includes a connector 40 for attaching the top drive 28 to the traveling block 22. A quill 46 is suspended from a swivel 42 through a motor 44, which drives rotation of the quill 46 within the top drive 28. The motor 44 drives rotation of the quill 46 through a gearbox in some embodiments, though the motor 44 could drive the quill 46 directly without a gearbox in other instances. The quill 46 (which is sometimes referred to as a main shaft or a drive stem) extends downwardly through other components of the top drive 28 and can be connected to a drill string 16 (e.g., with a saver sub) to cause the drill string 16 to rotate along with the quill 46.

The top drive 28 of FIG. 4 may also include a handling ring 48 connected to a pipe handler 50 and to an elevator 52. In some embodiments, the pipe handler 50 is connected to the bottom of a main body of the handling ring 48, and the elevator 52 is connected to the handling ring 48 via links. The links can include linear actuators (e.g., hydraulic cylinders) to enable raising and lowering of the elevator 52 with respect to the pipe handler 50. In operation, the elevator 52 can grip a drill pipe (or a stand of drill pipes) and raise the drill pipe into the pipe handler 50. This drill pipe may then be rotated by the pipe handler 50 to connect the drill pipe to the quill 46. The quill 46 may be axially supported in the top drive 28 by a main bearing, which can be located within the swivel 42 or a gearbox, for example.

In some embodiments, connecting the drill pipe to the quill 46 includes threading the drill pipe onto an intermediate component (e.g., a saver sub) connected to the quill 46. This can be done to reduce wear on the threaded end of the quill 46, although the drill pipe could be connected directly to the quill 46 in other embodiments. Once connected to the quill 46, the drill pipe can be added to the drill string 16 by lowering the drill pipe and threading it into the rest of the drill string 16. And in other instances, the elevator 52 can grip the top of the drill string 16 to allow the elevator to raise or lower the drill string (e.g., into engagement with the quill 46 or a saver sub connected to the quill).

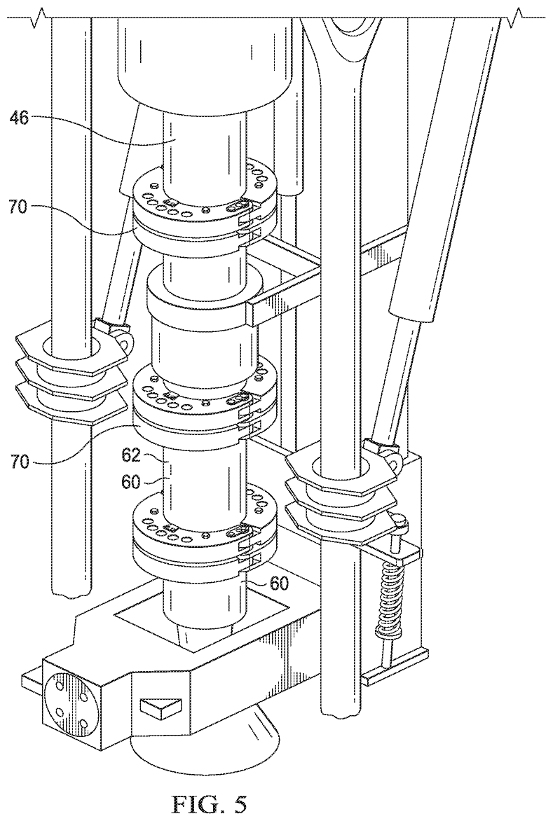

Referring now to FIG. 5, the top drive 28 may include one or more drill stem subs 60. In some embodiments, sub 60 may be a crossover (intermediate) sub, an upper or a lower inside blowout preventer sub, or a saver sub. Sub 60 may also be a tubular connected to other tubulars. Regardless of the number or type of sub 60, embodiments of a locking ring assembly 70 of this disclosure may be used to prevent unwanted rotation of a sub or tubular during breakout operations. Unlike the prior art locking rings, locking ring assembly 70 relies upon shear force rather than friction force to prevent unwanted rotation and loosening of connections during breakout. Additionally, the assembly 70 may be handled, opened, and closed as a single piece (interconnected) unit.

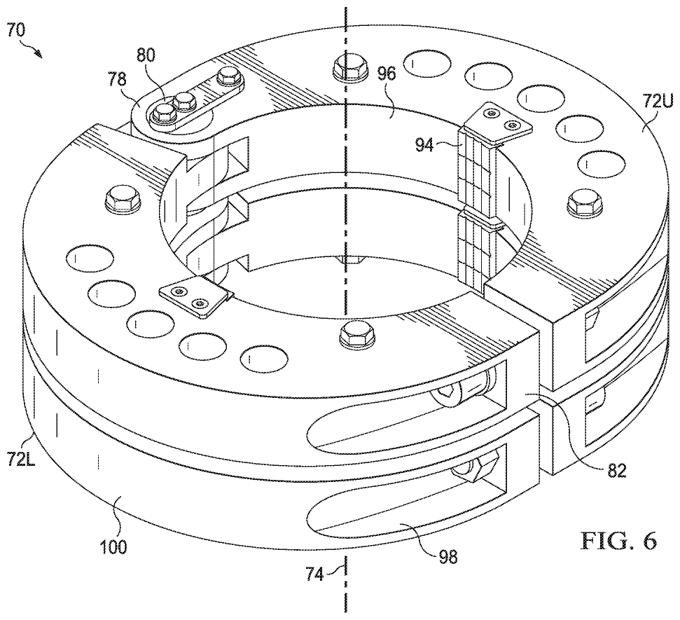

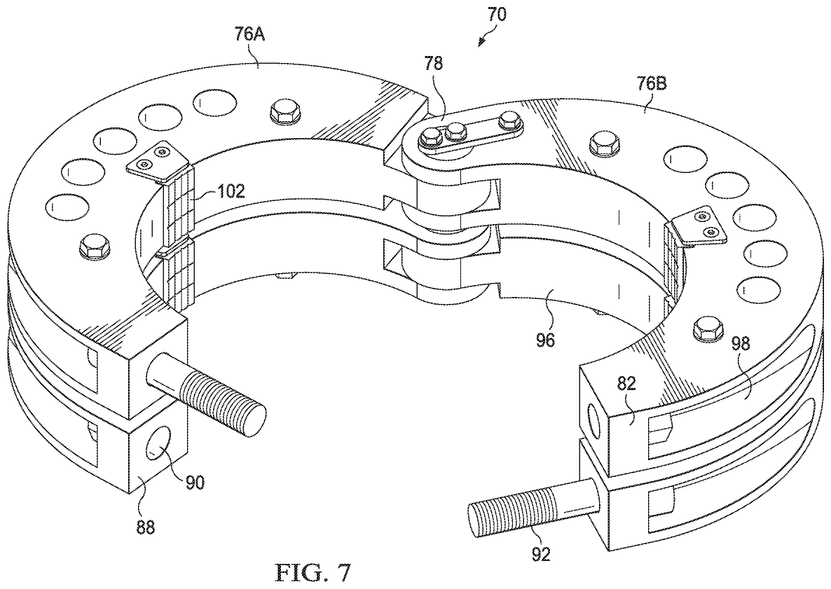

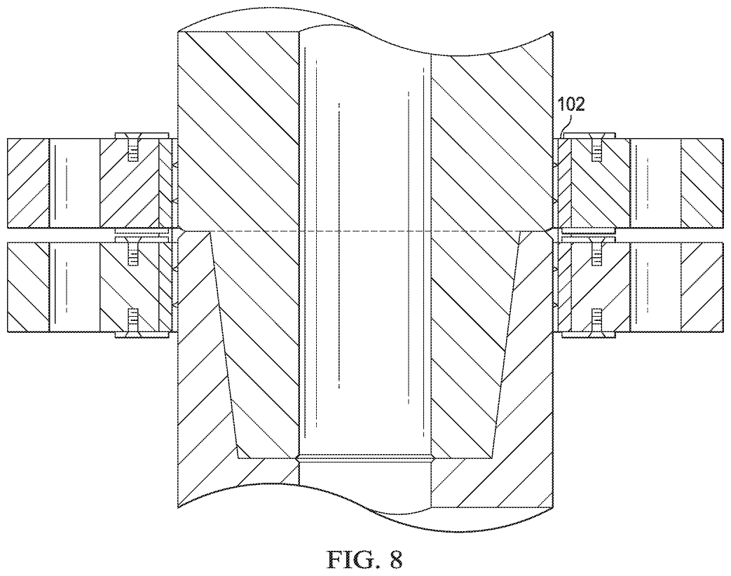

Referring now to FIGS. 6-8, embodiments of a locking ring assembly 70 of this disclosure include an upper ring 72U and a lower ring 72L that each include, respectively, convexities 94 located along an inner wall surface 96 of the locking ring assembly 70. The rings 72U, 72L are arranged coaxial to one another about a vertical centerline 74 of the locking ring assembly 70 and may be connected to one another by fasteners or screws 84 as a single assembly 70. The rings 72 may form a circular-shape.

In embodiments each ring 72U and 72L includes a first ring half 76A and a second ring half 76B having a hinged end 78 configured to receive a hinge pin 80 and a fastener end 82 configured to receive a fastener 92 (e.g. a locking screw or its equivalent). The fastener end 82 may be rotatable relative to the hinge end 78 between a fully opened and a fully closed position. In embodiments, the fastener end 82 may include a flange surface 88 including a fastener hole 90 and a longitudinally extending recess 98 located along an outer wall surface 100 into which the fastener 92 may be inserted and then threaded into the hole 90. Each half 76A and 76B may comprise a single fastener 92.

The convexities 94 may be in the form of a die 102 located along the inner wall surface 96 of each ring half 76. The convexities 94 may be triangular-shaped, square-shaped, rectangle-shaped, bumps, protuberances, or nodules, or other shapes preferable. The die 102 may cover a portion of the inner wall surface 96, with the remainder of the inner wall surface 96 being a smoother (no die) surface. In some embodiments, the die 102 spans an entire height of the inner wall surface 96.

The die 102 may be located about halfway between the hinged and fastener ends 78, 82. In other embodiments, each ring half 76 may include two or more dies 102 spaced-apart from one another. When the locking ring assembly 70 is located about a sub 60 or tubular—and the fasteners 92 are tightened to a predetermined torque so that the ring assembly 70 is in a fully closed and locked position—the fasteners 92 provide the needed force for the convexities 94 to at least partly penetrate an opposing outer wall surface 62 of the sub 60 or tubular.

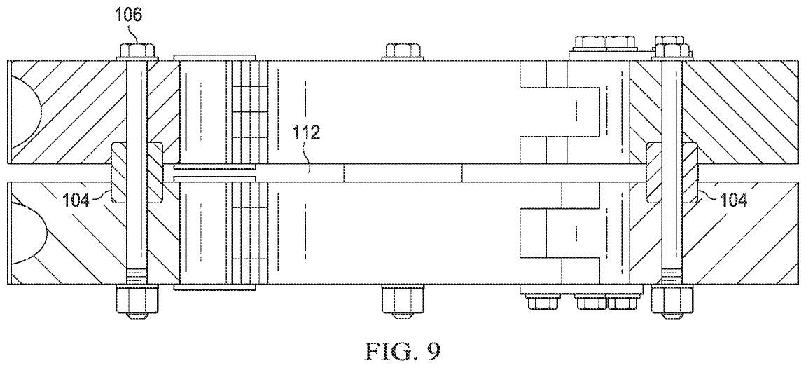

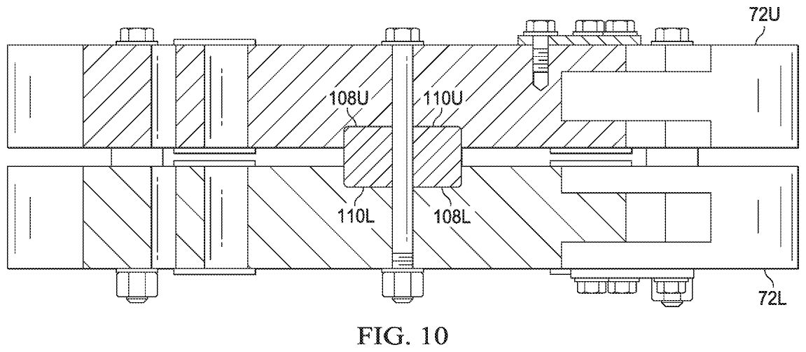

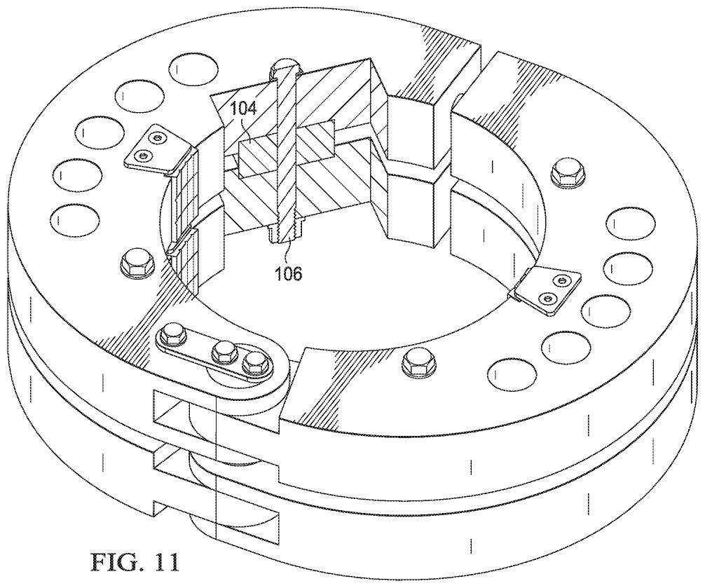

Referring to FIGS. 9-11, the locking ring assembly 70 may include one or more keys 104 installed between the upper and lower rings 72U, 72L. The key 104 reduces or prevents undesired or excessive torque experienced by one ring 72U or 72L being transmitted to the other ring 72L or 72U respectively. The key 104 may be configured so that the entire torque is transferred via the key 104. In some embodiments, the key 104 may be a block or spacer that receives a fastener 106 connecting the upper and lower rings 72U, 72L. An upper and a lower end 108U, 108L of the key 104 may reside in a complementary shaped recess 110U, 110L of the upper and lower rings 72U, 72L, respectively. The key 104 and recess 110 combination may be sized to provide a gap 112 between the two rings 72U, 72L. In some embodiments, each half 76A, 76B of the ring 72 includes two keys 104, one spaced left of the die 102, another spaced right of the die 102.

In embodiments, the locking ring assembly 70 is designed to provide a predetermined back-up holding or torque capacity. In embodiments, the back-up holding capacity is a multiple of the torque that will be experienced by a connected sub 60 or tubular when another sub 60 or tubular of the stem is being broke out. In some embodiments, the locking ring assembly 70 has a back-up holding capacity equal or superior to 50,000 foot pounds (about 68,000 newton meters).

Embodiments of a method of this disclosure for preventing a drill stem sub or tubular connection from loosening during a reverse torque operation performed on a drill stem may include clamping the locking ring assembly 70 about the drill stem sub 60, the locking ring assembly 70; wherein the clamping causes the one or more convexities 94 to at least partly penetrate the opposing outer wall surface 62 of the drill stem sub 60.

In some embodiments of the method, the locking ring assembly 70 comprises an upper ring 72U, a lower ring 72L arranged coaxial and connected to the upper ring 72U; the upper and lower rings 72U, 72L including a first and a second half 76A, 76B containing a hinge end 78 capable of receiving a hinge pin 80; a fastener end 82 capable of receiving at least one fastener 92, the fastener end 82 rotatable relative to the hinge end 78 between a fully opened and a fully closed position; and an inner peripheral wall surface 96 including at least a portion containing one or more convexities 94. The locking ring assembly 70 may further comprise a die 102, the one or more convexities 94 being located on the die 102. The one or more convexities 94 may be triangular-shaped, square-shaped, rectangle-shaped, bumps, protuberances, nodules, or other shapes preferable.

The method may also include the locking ring assembly 70 including means for transferring torque between the rings 72U, 72L. In some embodiments, the means may include at least one key 104 located between the upper and lower rings 72U, 72L. The first and second halves 76A, 76B of the rings 72 may also include a longitudinally extending recess 98 located along an outer peripheral wall surface 100 toward the fastener end 82.

Embodiments of a locking ring assembly 70 of this disclosure, or a top drive 28 of this disclosure, may include one or more of the following features: an upper ring 72U; a lower ring 72L arranged coaxial and connected to the upper ring 72U; the upper and lower rings 72U, 72L including a first and a second half 76, 76B containing a hinge end 78 capable of receiving a hinge pin 80; a fastener end 82 capable of receiving at least one fastener 92, the fastener end 82 rotatable relative to the hinge end 78 between a fully opened and a fully closed position; an inner peripheral wall surface 96 including at least a portion containing one or more convexities 94; a die 102, the one or more convexities 94 being located on the die 102; the one or more convexities 94 may be triangular-shaped, square-shaped, rectangle-shaped, bumps, protuberances, nodules, or other shapes preferable; means for transferring torque between the rings 72U, 72L; the means for transferring torque including at least one key 104 located between the upper and lower rings 72U, 72L and configured to transfer a torque experienced by the lower ring 72L, the upper ring 72U, or by both the lower and upper rings 72U, 72L; first and second halves 76A, 76B including a longitudinally extending recess 98 located along an outer peripheral wall surface 100 toward the fastener end 82.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the scope of the invention as defined by the following appended claims.

1. A locking ring assembly comprising:
an upper ring;
a lower ring arranged coaxial and connected to the upper ring;
the upper and lower rings being moveable between an opened and a closed position and further comprising an inner wall surface including at least a portion containing one or more convexities configured to, when in the closed position, at least partly penetrate an opposing wall surface of a tubular.

2. The locking ring assembly of claim 1, further comprising a die, the one or more convexities being located on the die.

3. The locking ring assembly of claim 1, further comprising at least one key located between the upper and lower rings.

4. The locking ring assembly of claim 3, wherein the at least one key is configured to transfer a torque experienced by the lower ring, the upper ring, or by both the lower and upper rings.

5. The top drive of claim 1, the upper and lower rings further including:
a hinged end configured to receive a hinge pin; and
a fastener end configured to receive a fastener.

6. A top drive comprising:
at least one drill stem sub; and
a locking ring assembly sized to encircle the at least one drill stem sub;
the locking ring assembly including:
an upper ring;
a lower ring arranged coaxial and connected to the upper ring;
the upper and lower rings being moveable between an opened and a closed position and further comprising an inner wall surface including at least a portion containing one or more convexities configured to, when in the closed position, at least partly penetrate an opposing wall surface of a tubular.

7. The top drive of claim 6, further comprising a die, the one or more convexities being located on the die.

8. The top drive of claim 6, further comprising at least one key located between the upper and lower rings.

9. The top drive of claim 8 wherein the at least one key is configured to transfer a torque experienced by the lower ring, the upper ring, or by both the lower and upper rings.

10. The top drive of claim 6, the upper and lower rings further including:
a hinged end configured to receive a hinge pin; and
a fastener end configured to receive a fastener.

11. A method for preventing a drill stem sub or tubular connection from loosening during a reverse torque operation performed on a drill stem or tubular, the method comprising;
clamping a locking ring assembly about a drill stem sub, the locking ring assembly including an inner wall surface containing one or more convexities;
wherein the clamping causes the one or more convexities to at least partly penetrate an opposing outer wall surface of the drill stem sub or tubular.

12. The method of claim 11, wherein the locking ring assembly comprises:
an upper ring; and
a lower ring arranged coaxial and connected to the upper ring;
the upper and lower rings being moveable between an unclamped and clamped position and further including an inner wall surface having at least a portion containing the one or more convexities.

13. The method of claim 11 further comprising:
limiting a transfer of a torque experienced by one of the upper or lower rings to another of the upper or lower rings, respectively

14. The method of claim 13, wherein the locking ring assembly includes at least one key located between the upper and lower rings.
